(19) United States
(12) Patent Application Publication
(10) Pub. No.: US 2011/0082026 A1
(43) Pub. Date: Apr. 7, 2011

(54) PHOTOCATALYST COMPOSITE AND PHOTOCATALYTIC FUNCTIONAL PRODUCT USING THE SAME

(75) Inventors: Yoshiaki SAKATANI, Niihama-shi (JP); Kohei Sogabe, Niihama-shi (JP); Makiko Hara, Sodegaura-shi (JP); Hitoshi Takami, Niihama-shi (JP)

(73) Assignee: SUMITOMO CHEMICAL COMPANY, LIMITED, Tokyo (JP)

(21) Appl. No.: 12/881,835

(22) Filed: Sep. 14, 2010

(30) Foreign Application Priority Data
Sep. 16, 2009 (JP) P 2009-214943
Mar. 29, 2010 (JP) P 2010-075937

(51) Int. Cl. B01J 23/54; B01J 21/08; B01J 31/06; B01J 23/72; B01J 23/42; B01J 23/52; B01J 23/46

(52) U.S. Cl. 502/159; 502/100; 502/232; 502/345; 502/339; 502/344; 502/325; 502/313

(57) ABSTRACT

The present invention provides a photocatalyst composite in which brittleness and ease of coming-off of a photocatalyst layer are reduced.

The photocatalyst composite includes a base material, at least the surface of which is formed of a plastic-deformable solid material; an inorganic particle layer containing inorganic particles disposed on the surface of the base material; and a photocatalyst layer containing a photocatalyst disposed on the surface of the inorganic particle layer; wherein at least one portion of voids in the inorganic particle layer is filled with the solid material, and the surface of the inorganic particle layer is coated with the solid material except for at least one portion.

### BACKGROUND OF THE INVENTION

1. Field of the Invention

The present invention relates to a photocatalyst composite, and a photocatalytic functional product using the same.

2. Description of the Related Art

When a semiconductor is irradiated with light having larger energy than that of a band gap thereof, electrons of a valence band are excited to a conduction band and holes are formed in the valence band. Since the holes thus formed have a strong oxidizing power and the excited electrons have a strong reducing power, an oxidation-reduction reaction is occurred on a substance contacted with the semiconductor. This oxidation-reduction reaction is called a photocatalytic reaction and the semiconductor capable of exhibiting the photocatalytic reaction is called a photocatalyst. Titanium oxide or tungsten oxide is known as such a photocatalyst.

In a structure in which the photocatalyst is supported on a resin or the like, there was such a problem that, when the photocatalyst is directly supported on the surface of the resin or the like, adhesion (adhesiveness) between a photocatalyst layer and a base material such as a resin or the like is impaired by the photocatalytic reaction and the photocatalyst easily comes off, and also photocatalytic activity of the photocatalytic structure drastically decreases.

Therefore, a decrease in adhesion between a photocatalyst layer and a resin base material due to the photocatalytic reaction is suppressed by providing an adhesive layer made of a silicone-modified resin, a polysiloxane-containing resin, a colloidal silica-containing resin or the like, that is inert to the photocatalytic reaction, between the photocatalyst layer and the resin base material (see WO 97/000134).

However, such an adhesive layer is insufficient in adhesion (adhesiveness) between a photocatalyst layer and an adhesive layer, or between an adhesive layer and a resin base material, it has been required a photocatalyst composite in which the photocatalyst layer does not come off.

### SUMMARY OF THE INVENTION

Thus, an object of the present invention is to provide a photocatalyst composite in which brittleness and ease of coming-off of a photocatalyst layer are reduced.

The present inventors have intensively studied so as to achieve the above object, and thus the present invention has been completed.

The present invention includes the following constitutions.

(1) A photocatalyst composite comprising a base material, at least the surface of which is formed of a plastic-deformable solid material; an inorganic particle layer containing inorganic particles disposed (or laminated) on the surface of the base material; and a photocatalyst layer containing a photocatalyst disposed (or laminated) on the surface of the inorganic particle layer; wherein the solid material is filled in at least one portion of voids in the inorganic particle layer, and the surface of the inorganic particle layer is coated with the solid material except for at least one portion.
(2) The photocatalyst composite according to (1), wherein the inorganic particles do not undergo plastic deformation under conditions where the solid material undergoes plastic deformation.
(3) The photocatalyst composite according to (1) or (2), wherein the inorganic particles constituting the inorganic particle layer are made of silica.
(4) The photocatalyst composite according to any one of (1) to (3), wherein the base material comprises a film of a solid material.
(5) The photocatalyst composite according to any one of claims (1) to (4), wherein the solid material is a thermoplastic resin.
(6) The photocatalyst composite according to any one of claims (1) to (5), wherein a noble metal or a noble metal precursor is supported on the photocatalyst of the photocatalyst layer.
(7) The photocatalyst composite according to (6), wherein the noble metal is at least one kind of a noble metal selected from Cu, Pt, Au, Pd, Ag, Ru, Ir and Rh.
(8) The photocatalyst composite according to (6) or (7), wherein the photocatalyst is a tungsten oxide particle.
(9) A photocatalytic functional product provided with the photocatalyst composite according to any one of (1) to (8).

According to the present invention, it is possible to obtain a photocatalyst composite in which brittleness and ease of coming-off of a photocatalyst layer are reduced while maintaining surface hardness derived from inorganic particles. As a result, it is made possible to produce a photocatalytic functional product capable of maintaining an original excellent photocatalytic activity.

### BRIEF DESCRIPTION OF THE DRAWINGS

FIG. 1 is a schematic explanatory diagram showing an example of a production process of an inorganic particle composite in the present invention.

FIG. 2 is a SEM (scanning electron microscope, the same shall apply hereinafter) micrograph (magnification: 10, 000 times) showing an enlarged surface and cross section of the inorganic particle structure obtained in Example 1.

FIG. 3 is a SEM micrograph (magnification: 10,000 times) showing an enlarged surface and cross section of the inorganic particle structure obtained in Example 1.

FIG. 4 is a SEM micrograph (magnification: 10,000 times) showing an enlarged surface and cross section of the inorganic particle structure obtained in Example 2.

FIG. 5 is a SEM micrograph (magnification: 10,000 times) showing an enlarged surface and cross section of the inorganic particle structure obtained in Comparative Example 3.

FIG. 6 is a SEM micrograph (magnification: 50,000 times) showing an enlarged surface and cross section of the inorganic particle structure obtained in Example 3.

FIG. 7 is a cross-sectional view schematically showing a state where the surface of an inorganic particle layer is coated with a solid material, FIG. 7(1) shows a case where voids of an inorganic particle layer is completely filled with a solid material, and also the entire surface of the inorganic particle layer is coated with the solid material, FIG. 7(2) shows a case where voids of an inorganic particle layer is completely filled with a solid material, and also only one portion (except for one portion) of the surface of the inorganic particle layer is coated with the solid material, FIG. 7(3) shows a case where only one portion of voids of an inorganic particle layer is coated with a solid material, and also only one portion (except for one portion) of the surface of the inorganic particle layer is coated with the solid material, and FIG. 7(4) shows a case where voids of an inorganic particle layer is completely filled with a solid material, and also only a lower surface of upper and lower surfaces is coated with the solid material.

### DETAILED DESCRIPTION OF THE INVENTION

Embodiments of the present invention will be described in detail.

### [Photocatalyst]

A photocatalyst composite in the present invention includes a photocatalyst layer on the surface thereof. The photocatalyst constituting the photocatalyst layer is a semiconductor that exhibits a photocatalytic activity under irradiation with ultraviolet ray or visible ray, and specific examples thereof include compounds of metal elements having a specific crystal structure, and oxygen, nitrogen, sulfur and fluorine. Examples of the metal element include Ti, Zr, Hf, V, Nb, Ta, Cr, Mo, W, Mn, Tc, Re, Fe, Co, Ni, Ru, Rh, Pd, Os, Ir, Pt, Cu, Ag, Au, Zn, Cd, Ga, In, Tl, Ge, Sn, Pb, Bi, La, Ce and the like. Examples of the compound include one, or two or more kinds of oxides, nitrides, sulfides, oxynitrides, oxysulfides, nitrofluorides, oxyfluorides and oxynitrofluorides of these metals. Of these compounds, oxides of Ti, W and Nb are preferred, and titanium oxide and tungsten oxide are particularly preferred. The photocatalysts may be used alone, and two or more kinds of them may be used in combination.

The titanium oxide particle constituting the photocatalyst in the present invention is not particularly limited as long as it is a particulate titanium oxide that exhibits a photocatalytic activity, and examples thereof include metatitanic acid particles, and titanium dioxide [TiO₂] particles in the form of an anatase, brookite or rutile crystal. The titanium oxide particles may be used alone, two or more kinds of them may be used in combination.

The metatitanic acid particle can be obtained, for example, by a method of hydrolyzing by heating an aqueous solution of titanyl sulfate.

The titanium dioxide particle can be obtained, for example, by a method (i) in which a base is added to an aqueous solution of titanyl sulfate or titanium chloride without heating to obtain a precipitate and the obtained precipitate is calcined; a method (ii) in which water, an aqueous solution of an acid or an aqueous solution of a base is added to titanium alkoxide to obtain a precipitate and the obtained precipitate is calcined; or a method (iii) of calcining metatitanic acid. The titanium dioxide particle obtained by these methods can be converted into a desired crystal form such as an anatase, brookite or rutile crystal type by adjusting the calcining temperature or the calcining time during calcining.

It is also possible to use, as the titanium oxide particle constituting the photocatalyst in the present invention, titanium oxide particles described in JP 2001-72419A, JP 2001-190953A, JP 2001-316116A, JP 2001-322816A, JP 2002-29749A, JP 2002-97019A, Internal Publication No. WO 01/10552, JP 2001-212457A, JP 2002-239395A, Internal Publication No. WO 03/080244, Internal Publication No. WO 02/053501, JP 2007-69093A, Chemistry Letters, Vol. 32, No. 2, P. 196-197 (2003), Chemistry Letters, Vol. 32, No 4, P. 364-365 (2003), Chemistry Letters, Vol. 32, No. 8, P. 772-773 (2003), and Chem. Mater., 17, P. 1548-1552 (2005) and the like. It is also possible to use titanium oxide particles obtained by the methods described in JP 2001-278625A, JP 2001-278626A, JP 2001-278627A, JP 2001-302241A, JP 2001-335321A, JP 2001-354422A, JP 2002-29750A, JP 2002-47012A, JP 2002-60221A, JP 2002-193618A, JP 2002-249319A and the like, the disclosure of which is incorporated by reference herein.

The particle diameter of the titanium oxide particle is not particularly limited, and is usually from 20 to 150 nm, and preferably from 40 to 100 nm, in terms of an average dispersion particle diameter in view of the photocatalytic activity.

The BET specific surface area of the titanium oxide particle is not particularly limited, and is usually from 100 to 500 m²/g, and preferably from 300 to 400 m²/g, in view of the photocatalytic activity.

The tungsten oxide particle constituting the photocatalyst in the present invention is not particularly limited as long as it is a particulate tungsten oxide that exhibits a photocatalytic activity and includes, for example, tungsten trioxide [WO₃] particles and the like. The tungsten oxide particles may be used alone, two or more kinds of them may be used in combination.

The tungsten trioxide particle can be obtained, for example, by a method (i) in which an acid is added to an aqueous solution of a tungstate to obtain tungstic acid as a precipitate and the obtained tungstic acid is calcined; a method (ii) in which ammonium metatungstate and ammonium paratungstate are thermolyzed by heating; or a meted (iii) of calcining a tungsten powder.

The particle diameter of the tungsten oxide particle is not particularly limited, and is usually from 50 to 200 nm, and preferably from 80 to 130 nm, in terms of an average dispersion particle diameter in view of the photocatalytic activity.

The BET specific surface area of the tungsten oxide is not particularly limited, and is usually from 5 to 100 m²/g, and preferably from 20 to 50 m²/g, in view of the photocatalytic activity.

It is preferred that the photocatalyst in the present invention also contains a noble metal or a precursor thereof. The noble metal is a compound or an element, that is supported on the surface of the photocatalyst, thus making it possible to exhibit electron-withdrawing properties, while the precursor of the noble metal is a compound that can be changed to the noble metal on the surface of the photocatalyst (for example, a compound that can be reduced into the noble metal under light irradiation). If the noble metal exists in a state of being supported on the surface of the photocatalyst, recombination of electrons excited to the conduction band under light irradiation and holes formed in the valence band is suppressed, thus making it possible to further enhance the photocatalytic activity.

The noble metal or precursor thereof preferably contains one or more kinds of atoms of metals selected from the group consisting of Cu, Pt, Au, Pd, Ag, Ru, Ir and Rh. More preferably, it contains one or more kinds of atoms of metals among Cu, Pt, Au and Pd. Examples of the noble metal include metals composed of the above metal atoms, or oxides and hydroxides of these metals, and examples of the precursor of the noble metal include nitrates, sulfates, halides, organic acid salts, carbonates, phosphates and the like of metals composed of the above metal atoms.

Preferred specific examples of the noble metal include metals such as Cu, Pt, Au, Pd and the like. Preferred specific examples of the precursor of the noble metal include precursors containing Cu, such as copper nitrates [Cu(NO₃)₂], copper sulfates [CuSO₄], copper chlorides [CuCl₂, CuCl], copper bromides [CuBr₂, CuBr], copper iodides [CuI], copper iodates [CuI₂O₆], ammonium copper chlorides [Cu(NH₄)₂Cl₄], copper oxychlorides [Cu₂Cl(OH)₃], copper acetates [CH₃COOCu, (CH₃COO)₂Cu], copper formates [(HCOO)₂Cu], copper carbonates [CuCO₃], copper oxalates [CuC₂O₄], copper citrates [Cu₂C₆H₄O₇], copper phosphates [CuPO₄] and the like; precursors containing Pt, such as platinum chlorides [PtCl₂, PtCl₄], platinum bromides [PtBr₂, PtBr₄], platinum iodides [PtI₂, PtI₄, platinum potassium chlorides [K₂(PtCl₄)], hexachloroplatinic acid [H₂PtCl₆], platinum sulfites [H₃Pt(SO₃)₂OH], platinum oxides [PtO₂], tetraammine platinum chlorides [Pt(NH₃)₄Cl₂], tetraammineplatinum hydrogen carbonates [C₂Hl₄N₄O₆Pt], tetraammineplatinum hydrogen phosphate [Pt(NH₃)₄HPO₄], tetraammineplatinum hydroxides [Pt(NH₃)₄(OH)₂], tetraammineplatinum nitrates [Pt(NO₃)₂(NH₃)₄] tetraammineplatinum tetrachloroplatinum [(Pt(NH₃)₄)(PtCl₄)], diammine dinitro platinum [Pt(NO₂)₂(NH₃)₂] and the like; precursors containing Au, such as gold chlorides [AuCl], gold bromides [AuBr], gold iodides [AuI], gold hydroxides [Au(OH)₂], tetrachloroauric acid [HAuCl₄], potassium tetrachloroaurate [KAuCl₄], potassium tetrachloroaurates [KAuBr₄], gold oxides [Au₂O₃] and the like; and precursors containing Pd, such as palladium acetates [(CH₃COO)₂Pd], palladium chlorides [PdCl₂], palladium bromides [PdBr₂], palladium iodides [PdI₂], palladium hydroxides [Pd(OH)₂], palladium nitrates [Pd(NO₃)₂], palladium oxides [PdO], palladium sulfates [PdSO₄], potassium tetrachloropalladates [K₂(PdCl₄)], potassium tetrabromopalladates [K₂(PdBr₄)], tetraammine palladium nitrates [Pd(NH₃)₄(NO₃)₂], tetraammine palladium tetrachloropalladium acid[(Pd(NH₃)₄)(PdCl₄)], ammonium tetrachloropalladates [(NH₄)₂PdCl₄], tetraammine palladium chlorides [Pd(NH₃)₄Cl₃], tetraammine palladium bromides [Pd(NH₃)₄Br₂] and the like. The noble metals or precursors thereof may be used alone, or two or more kinds of them may be used in combination. Also, needless to say, one or more kinds of noble metals and one or more kinds of precursors may be used in combination.

When the noble metal or precursor thereof is added, the content is usually from 0.005 to 0.6 part by mass, and preferably from 0.01 to 0.4 parts by mass, in terms of a metal atom based on 100 parts by mass of the total amount of the photocatalyst. When the content of the noble metal or precursor thereof is less than 0.005 parts by mass, the effect of improving the photocatalytic activity by the noble metal may not be sufficiently obtained. In contrast, when the content is more than 0.6 part by mass, the photocatalytic activity may decrease on the contrary.

The photocatalyst can be used as a photocatalyst dispersion dispersed in a dispersion medium. The dispersion medium constituting the photocatalyst dispersion is not particularly limited and an aqueous solvent containing water as a main component is usually used. Specifically, the dispersion medium may be water alone, or may be a mixed solvent of water and a water-soluble organic solvent. When the mixed solvent of water and a water-soluble organic solvent is used, the content of water is preferably 50% by mass or more. Examples of the water-soluble organic solvent include water-soluble alcohol solvents such as methanol, ethanol, propanol and butanol, acetone, methyl ethyl ketone and the like. The dispersion media may be used alone, or two or more kinds of them may be used in combination.

In the photocatalyst dispersion, the content of the dispersion medium is usually from 5 to 200 parts by mass, and preferably from 10 to 100 parts by mass, based on 100 parts by mass of the total amount of the photocatalyst. When the content of the dispersion medium is less than 5 parts by mass based on 100 parts by mass of the total amount of the photocatalyst, the photocatalyst is likely to be sedimented. In contrast, when the content is more than 200 parts by mass, it becomes disadvantageous in view of volume efficiency. Therefore, both cases are not preferred.

The hydrogen ion concentration of the photocatalyst dispersion is usually from pH 2.0 to pH 7.0, and preferably from pH 2.5 to pH 6.0. When the hydrogen ion concentration is less than pH 2.0, it is not easy to handle because of too strong acidity. In contrast, when the hydrogen ion concentration is more than pH 7.0, in case the photocatalyst is a tungsten oxide particle, the tungsten oxide particle may be dissolved. Therefore, both cases are not preferred. The hydrogen ion concentration of the photocatalyst dispersion may be usually adjusted by adding an acid. Examples of the acid that can be used to adjust the hydrogen ion concentration include nitric acid, hydrochloric acid, sulfuric acid, phosphoric acid, formic acid, acetic acid, oxalic acid and the like.

In the case of forming a photocatalyst layer on the surface of an inorganic particle composite using the photocatalyst dispersion in the present invention, a binder component for a photocatalyst layer may be mixed so as to more firmly hold the photocatalyst on the surface of the inorganic particle composite.

Examples of the binder for a photocatalyst layer include zirconium compounds such as zirconium formate, zirconium glycolate, zirconium oxalate, zirconium hydroxide, zirconium oxide and the like; tin compounds such as tin hydroxide, tin oxide and the like; niobium compounds such as niobium hydroxide, niobium oxide and the like; silicone alkoxides such as tetraethoxysilane(ethyl silicate), methyl silicate(tetramethoxysilane), methyltriethoxysilane, methyltriethoxysilane and the like; and silicone compounds such as colloidal silica, silicon oxide and the like. These binders can be used alone, or two or more kinds of them can also be used in combination. It is also possible to use known binders for a photocatalyst layer described in JP H08-67835A, JP H09-25437A, JP H10-183061A, JP H10-183062A, JP H10-168349A, JP H10-225658A, JP H11-1620A, JP H11-1661A, JP 2004-059686A, JP 2004-107381A, JP 2004-256590A, JP 2004-359902A, JP 2005-113028A, JP 2005-230661A, JP 2007-161824A and the like, the disclosure of which is incorporated by reference herein.

There is no particular limitation on the method for producing a photocatalyst dispersion in the present invention, and the photocatalyst dispersion can be obtained by appropriately adding in the respective components described above in a dispersion medium, followed by mixing. An embodiment of a mixing order and a mixing method of the respective components will be described below.

When the titanium oxide particle and the tungsten oxide particle are used, for example, as the photocatalyst, mixing of the titanium oxide particle and the tungsten oxide particle is preferably an aspect in which the titanium oxide particle is added and dispersed in a dispersion medium to prepare a titanium oxide particle dispersion and the tungsten oxide particle or a tungsten oxide particle dispersion prepared by dispersing the tungsten oxide particle in a dispersion medium is added, followed by mixing, and more preferably an aspect in which a titanium oxide particle dispersion is mixed with a tungsten oxide particle dispersion. In the case of preparing the titanium oxide particle dispersion or the tungsten oxide particle dispersion, it is preferred to subject to a conventionally known dispersion treatment in which a media agitation type disperser is used, after the respective particles are mixed with a dispersion medium.

In the case of adding the noble metal or precursor thereof, they may be mixed in a state as it is, or may be mixed with a photocatalyst particle dispersion in a state of being dissolved or dispersed in a dispersion medium.

When the precursor of the noble metal is added in the photocatalyst particle dispersion, the photocatalyst particle dispersion is preferably irradiated with light after the addition. The light to be irradiated is not particularly limited as long as it is light having larger energy than that of a band gap of photocatalyst particles, and may be visible ray or ultraviolet ray. When the photocatalyst particle dispersion is irradiated with light, the precursor is reduced into a noble metal by electrons formed by light excitation, and thus the noble metal is supported on the surface of photocatalyst particles. In case the precursor is added to the photocatalyst particle dispersion, even if the photocatalyst particle dispersion is not irradiated with light, the precursor is converted into a noble metal at the time when the photocatalyst layer formed by the obtained photocatalyst particle dispersion is irradiated with light, and thus the photocatalytic ability does not deteriorate. The above light irradiation may be conduced at any stage as long as the precursor has already added in the photocatalyst particle dispersion.

When the precursor of the noble metal is added in the photocatalyst particle dispersion, for the purpose of efficiently converting into the noble metal, methanol, ethanol, oxalic acid or the like can be appropriately added in the photocatalyst particle dispersion before the light irradiation as long as the effects of the present invention are not adversely affected.

In the case of adding a binder component for a photocatalyst layer in the photocatalyst particle dispersion, the binder component for a photocatalyst layer may be added at any stage.

### [Inorganic Particles]

Examples of the inorganic particle in the present invention include metal oxides such as iron oxide, magnesium oxide, aluminum oxide, silicon oxide (silica), titanium oxide, cobalt oxide, copper oxide, zinc oxide, cerium oxide, yttrium oxide, indium oxide, silver oxide, tin oxide, holmium oxide, bismuth oxide, indium tin oxide and the like; complex oxides such as indium tin oxide and the like; metal salts such as calcium carbonate, barium sulfate and the like; and inorganic layered compounds such as clay mineral, graphite, carbon-based intercalation compound and the like. Of these inorganic particles, silicon oxide (silica) is preferably used.

Examples of the inorganic layered compound include kaolinite groups, antigorite groups, smectite groups, vermiculite groups, mica groups and the like. Specific examples thereof include kaolinite, dickite, nacrite, halloysite, antigorite, chrysotile, pyrophyllite, montmorillonite, hectorite, tetracyclic mica, sodium teniolite, muscovite, margarite, talc, vermiculite, phlogopite, xanthophyllite, chlorite and the like.

The particle size of the inorganic particles is preferably from 1 to 10,000 nm. When an aspect ratio of the inorganic particle is 2 or less, the particle size is from 1 to 500 nm, preferably from 1 to 200 nm, and more preferably from 2 to 100 nm. When the inorganic particle is an inorganic layered compound, the particle diameter is from 10 to 3,000 nm, preferably from 20 to 2,000 nm, and more preferably from 100 to 1,000 nm.

### [Solid Material]

The solid material in the present invention is not particularly limited as long as it has plasticity. Herein, plasticity refers to a property in which permanent strain is generated when stress exceeds an elastic limit, resulting in continuous deformation. The phrase “solid material undergoes plastic deformation” means that stress exceeding an elastic limit is applied on a solid material having plasticity by heat and/or pressure to generate permanent strain, and thus the solid material is deformed and the solid material becomes the state where the deformed state is maintained even when the stress is removed. Examples of the solid material include synthetic resins such as a thermoplastic resin and a thermosetting resin.

When the resin is a thermosetting resin, for example, an aramid resin, a polyimide resin, an epoxy resin, an unsaturated polyester resin, a phenol resin, a urea resin, a polyurethane resin, a melamine resin, a benzoguanamine resin, a silicone resin, a melamine urea resin and the like are exemplified. When the resin is a thermoplastic resin, for example, a polycondensation resin, a resin obtained by polymerizing a vinyl monomer and the like are exemplified.

Examples of the polycondensation thermoplastic resin include polyester-based resins such as polyethylene terephthalate, polyethylene naphthalate, polylactic acid, biodegradable polyester, polyester-based liquid crystal polymer and the like; polyimide resins such as ethylenediamine-adipic acid polycondensate (nylon-66), nylon-6, nylon-12, polyamide-based liquid crystalpolymer and the like; polyether-based resins such as polycarbonate resin, polyphenylene oxide, polymethylene oxide, acetal resin and the like; and polysaccharides-based resins such as cellulose and derivatives thereof.

Examples of the resin obtained by polymerizing the vinyl monomer include:

polyolefin-based resins (detail described later);
resins containing a constituent unit derived from an aromatic hydrocarbon compound, such as polystyrene, poly-α-methylstyrene, styrene-ethylene-propylene copolymer (polystyrene-poly(ethylene/propylene) block copolymer), styrene-ethylene-butene copolymer (polystyrene-poly(ethylene/butene) block copolymer), styrene-ethylene-propylene-styrene copolymer (polystyrene-poly(ethylene/propylene)-polystyrene block copolymer), ethylene-styrene copolymer and the like;
polyvinyl alcohol-based resins such as polyvinyl alcohol, polyvinyl butyral and the like;
polymethyl methacrylate, acrylic resins containing, as a monomer, methacrylic acid ester, acrylic acid ester, methacrylic acid amide, acrylic acid amide and the like;
chlorine-based resins such as polyvinyl chloride, polyvinylidene chloride and the like; and fluorine-based resins such as polytetrafluoroethylene, ethylene-tetrafluoroethylene copolymer, tetrafluoroethylene-hexafluoropropylene copolymer, ethylene-tetrafluoroethylene-hexafluoropropylene copolymer, polyvinylidene fluoride and the like.

The above polyolefin-based resin is a resin obtained by polymerizing one or more kinds of monomers selected from α-olefin, cycloolefin and polar vinyl monomer. The polyolefin-based resin may be a modified resin produced by further modifying a polyolefin-based resin obtained by polymerizing a monomer. When the polyolefin-based resin is a copolymer, the copolymer may be a random copolymer or a block copolymer.

Examples of the polyolefin-based resin include a propylene-based resin and an ethylene-based resin. These resins will be described in detail below.

### [Propylene-Based Resin]

The propylene-based resin is a resin composed mainly of a propylene-derived constituent unit and includes, in addition to a homopolymer of propylene, a copolymer of propylene and a comonomer that is copolymerizable therewith.

The comonomer to be copolymerized with propylene includes, for example, ethylene and α-olefin having 4 to 20 carbon atoms. In this case, examples of the α-olefin having 4 to 20 carbon atoms include 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, 2-methyl-1-hexene, 2,3-dimethyl-1-pentene, 2-ethyl-1-pentene, 2-methyl-3-ethyl-1-butene, 1-octene, 5-methyl-1-heptene, 2-ethyl-1-hexene, 3,3-dimethyl-1-hexene, 2-methyl-3-ethyl-1-pentene, 2,3,4-trimethyl-1-pentene, 2-propyl-1-pentene, 2,3-diethyl-1-butene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene and the like.

Among the α-olefin, α-olefin having 4 to 12 carbon atoms is preferred, and specific examples thereof include 1-butene, 2-methyl-1-propene; 1-pentene, 2-methyl-1-butene, 3-methyl-1-butene; 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene; 1-heptene, 2-methyl-1-hexene, 2,3-dimethyl-1-pentene, 2-ethyl-1-pentene, 2-methyl-3-ethyl-1-butene; 1-octene, 5-methyl-1-heptene, 2-ethyl-1-hexene, 3,3-dimethyl-1-hexene, 2-methyl-3-ethyl-1-pentene, 2,3,4-trimethyl-1-pentene, 2-propyl-1-pentene, 2,3-diethyl-1-butene; 1-nonene; 1-decene; 1-undecene; 1-dodecene and the like. In view of copolymerizability, 1-butene, 1-pentene, 1-hexene and 1-octene are preferred, and 1-butene and 1-hexene are more preferred.

Preferred propylene-based copolymer includes a propylene/ethylene copolymer and a propylene/1-butene copolymer.

### [Ethylene-Based Resin]

The ethylene-based resin is a resin composed mainly of an ethylene-derived constituent unit and may be, in addition to a homopolymer of ethylene, a copolymer of ethylene and a comonomer that is copolymerization therewith. For example, an ethylene-α-olefin copolymer, a high-density polyethylene, a high-pressure low-density polyethylene, an ethylene-ethylene-based unsaturated carboxylic acids copolymer and the like are exemplified.

The ethylene-α-olefin copolymer is an ethylene-α-olefin copolymer obtained by copolymerizing ethylene with α-olefin having 4 to 12 carbon atoms, and examples of the α-olefin having 4 to 12 carbon atoms include butene-1, pentene-1, hexene-1, heptene-1, octene-1, nonene-1, decene-1, dodecene-1,4-methyl-pentene-1,4-methyl-hexene-1, vinylcyclohexane, vinylcyclohexene, styrene, norbornene, butadiene, isoprene and the like. It is preferably hexene-1,4-methyl-pentene-1 or octene-1. Furthermore, norbornene or dimethanooctahydronaphthalene (DMON) is also preferred as cycloolefin that is α-olefin in a broad sense. The above α-olefins having 4 to 12 carbon atoms may be used alone, or at least two kinds of them may be used in combination.

### [Ethylene-Ethylene-Based Unsaturated Carboxylic Acids Copolymer]

The ethylene-ethylene-based unsaturated carboxylic acids copolymer refers to a copolymer of ethylene and ethylene-based unsaturated carboxylic acids. The ethylene-based unsaturated carboxylic acids are carboxylic acids that are compounds having an ethylene-based unsaturated bond as a polymerizable carbon-carbon unsaturated bond such as a carbon-carbon double bond.

The ethylene-based unsaturated carboxylic acids include, for example, a vinyl ester of a saturated carboxylic acid, vinyl ester of an unsaturated carboxylic acid, and an α,β-unsaturated carboxylic acid ester.

The vinyl ester of the saturated carboxylic acid is preferably a vinyl ester of a saturated aliphatic carboxylic acid having about 2 to 4 carbon atoms and includes, for example, vinyl acetate, vinyl propionate, vinyl butyrate and the like. The vinyl ester of the unsaturated carboxylic acid is preferably a vinyl ester of an unsaturated aliphatic carboxylic acid having about 2 to 5 carbon atoms and includes, for example, vinyl acrylate, vinyl methacrylate and the like. The α,β-unsaturated carboxylic acid ester is preferably an ester of an α,β-unsaturated carboxylic acid having about 3 to 8 carbon atoms, and examples thereof include alkyl esters of acrylic acid, such as methyl acrylate, ethyl acrylate, n-propyl acrylate, isoopyl acrylate, n-butyl acrylate, isobutyl acrylate, tert-butyl acrylate and the like; and alkyl esters of methacrylic acid, such as methyl methacrylate, ethyl methacrylate, n-propyl methacrylate, isoopyl methacrylate, n-butyl methacrylate, isobutyl methacrylate, tert-butyl methacrylate and the like. Of the ethylene-based unsaturated carboxylic acids, vinyl acetate, methyl acrylate, ethyl acrylate, n-butyl acrylate and methyl methacrylate are preferred, and vinyl acetate is more preferred. The ethylene-based unsaturated carboxylic acids are used alone, or two or more kinds of them are used in combination. Also, an ethylene-based unsaturated carboxylic acids hydrolyzate, for example, a saponified ethylene-vinyl acetate copolymer obtained by hydrolysis of an ethylene-vinyl acetate copolymer is preferably used.

### [Modified Polyolefin-Based Resin]

The above polyolefin-based resin such as a propylene-based resin or an ethylene-based resin may be modified. Examples of the modified polyolefin-based resin include the following resins such as (1) to (3):

(1) a modified polyolefin-based resin obtained by graft polymerization of a homopolymer of olefin with an unsaturated carboxylic acid and/or derivatives thereof;
(2) a modified polyolefin-based resin obtained by graft polymerization of a copolymer of at least two kinds of olefins with an unsaturated carboxylic acid and/or derivatives thereof; and
(3) a modified polyolefin-based resin obtained by graft polymerization of a block copolymer, that is obtained by homopolymerization of olefin and copolymerization of at least two kinds of olefins, with an unsaturated carboxylic acid and/or derivatives thereof.

Preferably, the modified polyolefin resin includes the following resins (4) and (5):

(4) a modified polyolefin-based resin obtained by graft polymerization of a polyolefin resin containing a unit derived from ethylene and/or propylene as a main constituent unit of a polymer with maleic anhydride; and
(5) a modified polyolefin-based resin obtained by copolymerization of olefin containing ethylene and/or propylene as main components with a methacrylic acid glycidyl ester or maleic anhydride.

As the other modified polyolefin-based resin, for example, those obtained by reacting a monomer (coupling agent) containing an element such as silicon, titanium or fluorine, or a polymer containing the same with a polyolefin-based resin are exemplified.

The inorganic particles and solid materials may be respectively used alone, or plural kinds thereof may be used in combination. It is also possible to form an inorganic particle structure by using particles each having a different average particle diameter in combination.

When the solid material also serves as a base material or the surface of the inorganic particles is contact with that of the solid material, the shape is preferably a plate shape such as a film or sheet shape. In this case, there is no particular limitation on the thickness of the solid material.

### [Base Material]

The base material to be used in the present invention refers to the below described material that supports an inorganic particle structure in which a solid material having plasticity and an inorganic particle layer are laminated (or disposed). The base material is not particularly limited as long as it supports the inorganic particle structure and, specifically, metal, resin, glass, ceramic, paper and cloth are used in an optional shape (plate such as film or sheet, bar, fiber, sphere, three-dimensional structure, etc.).

### [Inorganic Particle Structure]

The inorganic particle structure is composed of a layer of a base material of a plastic-deformable solid material, and an inorganic particle that is adjacent to the base material and does not undergo plastic deformation under conditions where the solid material undergoes plastic deformation, and an inorganic particle structure in which at least the inorganic particle layer includes voids is formed. Usually, this inorganic particle layer has a porous structure and at least one portion of pores may be communicated. Communication of the inorganic particle layer makes it easy to fill voids of the inorganic particle structure by plastic deformation of the solid material described hereinafter.

Porosity (a void ratio) of the inorganic particle layer in the present invention is not limited, and is 5% by volume or more and 90% by volume or less based on the total volume of the inorganic particle layer. When the porosity (void ratio) of the inorganic particle layer is more than 90% by volume based on the total volume of the inorganic particle layer, the strength of the inorganic particle layer may be insufficient. In contrast, when the porosity is less than 5% by volume, the solid material to be filled in the inorganic particle layer may decrease, resulting in insufficient strength of the inorganic particle layer.

The method for producing an inorganic particle structure includes, for example, the following methods:

Method 1: a method in which a coating solution containing an inorganic particle is applied on a plate- or film-shaped solid material, namely, a base material of a solid material and then dried to form an inorganic particle structure; and
Method 2: a method in which a coating solution containing a solid material particle is applied on a base material and dried to form a solid material layer on the surface of the body of the base material to obtain a base material, and then a coating solution containing an inorganic particle is applied and dried to laminate an inorganic particle layer on the solid material layer.

The step of coating a coating solution containing inorganic particles and drying the coating solution may be performed plural times.

In the above method 1, a coating solution containing an inorganic particle and a liquid dispersion medium is prepared, while in the method 2, a coating solution containing a particulate solid material and a liquid dispersion medium, and a coating solution containing an inorganic particle and a liquid dispersion medium are respectively prepared.

The liquid dispersion medium in the present invention may have a function of dispersing particles, and may be water, a volatile organic solvent, or a mixed solvent of water and a volatile organic solvent. In order to improve dispersion of the particle in the solvent, a surface treatment may be performed, or dispersion medium electrolyte or a dispersion aid may be added. The volatile organic solvent is preferably, for example, methanol, ethanol, propanol, acetone or methyl ethyl ketone.

When the particles are dispersed in a colloidal form, pH adjustment or addition of an electrolyte and a dispersing agent can be optionally performed. In order to obtain an inorganic particle-dispersed coating solution containing particles dispersed uniformly therein, techniques such as stirring using a stirrer, ultrasonic dispersion, ultrahigh-pressure air gun dispersion (ultrahigh-pressure air gun homogenizer) and the like may be optionally applied. The concentration of the coating solution is not particularly limited, and is desirably from 1 to 50% by mass based on the coating solution so as to maintain stability of the particles in the solution.

When the inorganic particles is silica and the coating solution is in a colloidal state, it is preferred to add cations such as ammonium ions, alkaline metal ions, alkaline earth metal ions and the like to the coating solution.

To the coating solution, additives such as surfactants, polyhydric alcohols, soluble resins, dispersible resins, organic electrolytes and the like may be added for the purpose of stabilizing dispersion of the particles.

When the coating solution contains surfactants, it is desired that the content is usually 0.1 part by mass or less based on 100 parts by mass of the liquid dispersion medium. The surfactant to be used is not particularly limited and includes, for example, anionic surfactants, cationic surfactants, nonionic surfactants, amphoteric surfactants and the like.

Examples of the anionic surfactant include alkali metal salts of carboxylic acid, and specific examples thereof include sodium caprylate, potassium caprylate, sodium decanoate, sodium caproate, sodium myristate, potassium oleate, tetramethylammonium stearate, sodium stearate and the like. In particular, alkali metal salts of carboxylic acid having an alkyl chain of 6 to 10 carbon atoms are preferred.

Examples of the cationic surfactant include cetyltrimethylammonium chloride, dioctadecyldimethylammonium chloride, N-octadecylpyridinium bromide, cetyltriethylphosphonium bromide and the like.

Examples of the nonionic surfactant include a sorbitan fatty acid ester, a glycerin fatty acid ester and the like.

Examples of the amphoteric surfactant include 2-alkyl-N-carboxymethyl-N-hydroxyethyl imidazolinium betaine, lauric acid amide propyl betaine and the like.

When the coating solution contains a polyhydric alcohol, usually, the content is preferably 10 parts by mass or less, and more preferably 5 parts by mass or less, based on 100 parts by mass of the liquid dispersion medium. It is possible to improve antistatic properties of the inorganic particle structure by adding a small amount of the polyhydric alcohol. Examples of the polyhydric alcohol to be used include, but are not limited to, glycol-based polyhydric alcohols such as ethylene glycol, diethylene glycol, polyethylene glycol, propylene glycol, dipropylene glycol, polypropylene glycol and the like; glycerin-based polyhydric alcohols such as glycerin, diglycerin, polyglycerin and the like; and methylol-based polyhydric alcohols such as pentaerythritol, dipentaerythritol, tetramethylolpropane and the like.

When the coating solution contains the soluble resin, usually, the content is preferably 1 part by mass or less, and more preferably 0.1 part by mass or less, based on 100 parts by mass of the liquid dispersion medium. It is sometimes possible to make it easy to form the inorganic particle structure and to impart a function of the soluble resin to the inorganic particle structure by adding a small amount of the soluble resin.

The soluble resin to be used herein is not particularly limited as long as it is dissolved in the liquid dispersion medium, and examples thereof include polyvinyl alcohol-based resins such as a polyvinyl alcohol, an ethylene-vinyl alcohol copolymer, a copolymer containing a vinyl alcohol unit and the like; and polysaccharides such as cellulose, methyl cellulose, hydroxymethyl cellulose, carboxymethyl cellulose and the like.

When the coating solution contains the dispersible resin, usually, the content is preferably 10 parts by mass or less, and more preferably 5 parts by mass or less, based on 100 parts by mass of the liquid dispersion medium. It is sometimes possible to make it easy to form the inorganic particle structure and to impart a function of the dispersible resin to the inorganic particle structure by adding a small amount of the dispersible resin.

The dispersible resin to be used herein is not particularly limited as long as it is dispersed in the liquid dispersion medium, and all resins described above can be used. The dispersible resin is preferably used in the form of various suspensions, or emulsions that are dispersed in a medium in a particulate form. Examples thereof include a fluorine resin dispersion, a silicone resin dispersion, an ethylene-vinyl acetate copolymer resin dispersion, a polyvinylindene chloride resin dispersion and the like.

If necessary, flocculating agents can be added in the case of obtaining a coating solution. By the addition of the flocculating agent, inorganic particles form aggregation particles and, finally, an inorganic particle structure having secondary or thirdly controlled structure can be obtained.

Examples of the flocculating agent include acidic compounds such as hydrochloric acid, or an aqueous solution thereof; alkaline compounds such as sodium hydroxide, or an aqueous solution thereof; isopropyl alcohol; ionic liquid and the like.

The coating solution can be applied, for example, by a known method such as a gravure coating, reverse coating, brush roll coating, spray coating, kiss coating, die coating, dipping, bar coating method or the like. When using a method such as an ink-jet printing, screen printing, flexo printing, gravure printing method or the like, it is possible to provide an inorganic particle layer with any pattern.

There is no limitation on the number of coating of the coating solution and the amount of the coating solution to be coated per one time, and the amount of the coating solution to be coated per one time is preferably from 0.5 g/m² to 40 g/m² so as to coat in a uniform thickness.

Regarding the drying method, the pressure and temperature upon removal of the liquid dispersion medium can be appropriately selected according to the inorganic particle, the solid material and the liquid dispersion medium to be used. For example, when the liquid dispersion medium is water, the liquid dispersion medium can be removed under a normal pressure at 25° C. to 60° C.

### [Inorganic Particle Composite]

The inorganic particle composite in the present invention is in a state where at least one portion of an inorganic particle layer is chemically and/or physically bonded via a solid material, and is obtained by allowing a solid material contained in an inorganic particle structure to undergo plastic deformation, and filling the solid material in at least one portion of voids of the inorganic particle layer. In the present invention, the state where “the solid material is filled in.” includes a state where one portion of voids among a lot of voids are filled with the solid material and other voids are not filled therewith, and a state where only one portion of one void is filled with the solid material. Needless to say, all voids may be completely filled with the solid material, but the entire surface of the inorganic particle layer is not coated with the solid material. The degree of plastic deformation and the degree of filling of the solid material vary depending on the objective function of the inorganic particle composite.

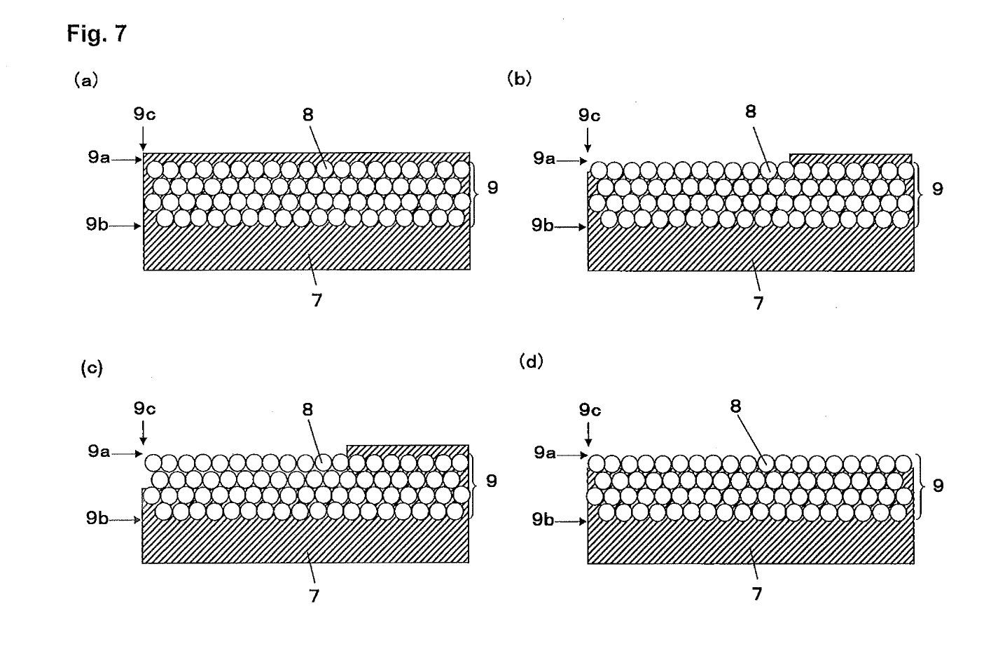

FIG. 7 is a cross-sectional view schematically showing a state where the surface of an inorganic particle layer is coated with a solid material and a state where voids of the surface of an inorganic particle layer are filled with a solid material.

Using FIG. 7(a) to FIG. 7(b), filling of voids of the inorganic particle layer with the solid material and coating the surface of the inorganic particle layer will be described in detail below.

FIG. 7(a) shows the case where all plural voids of an inorganic layer 9 to be formed between plural inorganic particles 8 are completely filled with a solid material 7, and also the entire surface of the inorganic particle layer 9 is coated with the solid material 7. In this case, since the surface of the inorganic particle layer 9, namely, all of a top surface 9a, a bottom surface 9b and a side surface 9c are coated with the solid material 7, when a photocatalytic layer is formed on the inorganic particle layer 9, the solid material 7 exists between the inorganic particle layer 9 and the photocatalytic layer by all means. As a result, adhesion between the inorganic particle layer 9 and the photocatalytic layer decreases. Therefore, the state shown in FIG. 7(a) is sometimes unsuited for the photocatalyst composite according to the present invention.

In the Example shown in FIG. 7(b), all of plural voids of an inorganic particle layer 9 to be formed between plural inorganic particles 8 are completely filled with a solid material 7. However, one portion of the surface of the inorganic particle layer 9 (one portion of a top surface 9a of the inorganic particle layer 9 in the drawing) is not coated with the solid material 7. Namely, the surface of the inorganic particle layer 9 is coated with the inorganic particle 7, leaving one portion of the surface. In this case, since the photocatalyst layer is formed on the top surface 9a of the inorganic particle layer 9, the photocatalyst layer and the organic particle layer 9 (namely, the photocatalyst and the inorganic particle 8) are directly contacted with each other, it is possible to achieve strong (or firm) adhesion between the photocatalyst layer and the inorganic particle layer 9. Therefore, the embodiment is suited for the catalyst composite according to the present invention.

In the example showing FIG. 7(c), one portion of plural voids of an inorganic particle layer 9 formed between plural inorganic particles 8 is not filled with a solid material 7 and the remainder of the plural voids is filled with a solid material 7. Also, one portion of the surface of the inorganic particle layer 9 (one portion of a top surface 9a of the inorganic particle layer 9 in the drawing) is not coated with the solid material 7. Namely, the surface of the inorganic particle layer 9 is coated with the inorganic particle 7, leaving one portion of the surface.

In the embodiment shown in FIG. 7(c), it is also possible to achieve strong adhesion between the photocatalyst layer and the inorganic particle layer 9 in the same manner as in the embodiment shown in FIG. 7(b). Therefore, the embodiment is suited for the catalyst composite according to the present invention.

In the example shown in FIG. 7(d), only a bottom surface 9b among a top surface 9a and a bottom surface 9b of an inorganic particle layer 9 is coated with a solid material 7, and the top surface 9a (the entire top surface 9a of the inorganic particle layer 9) is not coated therewith. The example shown in FIG. 7(d) is one of the embodiments in which the surface of the inorganic particle layer 9 is coated with the solid material 7, leaving one portion.

In the embodiment shown in FIG. 7(d), since a solid material 7 is not present on a top surface 9a and a photocatalyst layer and the entire top surface 9a of an inorganic particle layer 9 are directly contacted with each other, there is an advantage that it is possible to achieve more strong adhesion between the photocatalyst layer and the inorganic particle layer 9.

In the embodiment shown in FIG. 7(d), all of plural voids of the inorganic particle layer 9 to be formed between plural inorganic particles 8 are completely filled with the solid material 7, but there is no limitation. Namely, the embodiment of FIG. 7(d) includes a configuration of voids, in the same manner as in the embodiment shown in FIG. 7(c), where one portion of plural voids of the inorganic particle layer 9 to be formed between inorganic particles 8 is not filled with the solid material 7 and the remainder of the plural voids is filled with the solid material 7.

Means for plastic deformation of a solid material is not limited to particular means for plastic deformation of a solid material and examples thereof include a pressurization method. Examples of the pressurization method include a press method in which an inorganic particle structure is pressurized in a state of being interposed between plates, a roll press method capable of continuously pressurizing in a state of being interposed between rolls, and a method in which a static pressure is applied in a liquid. The pressure is not particularly limited as long as it is more than an atmospheric pressure, and the pressure may be varied according to the degree of plasticity of the solid material. When softening of the solid material proceeds and large permanent strain is generated under low stress, the pressure may be a low pressure. In contrast, when a high stress is necessary, a high pressure is required. The pressure is, for example, 0.1 kgf/cm² or more, preferably 1 kgf/cm² or more, more preferably 10 kgf/cm² or more, and particularly preferably 100 kgf/cm² or more. The number of pressurization is not particularly limited and pressurization operations under plural conditions may be used in combination.

The pressurization conditions are not particularly limited and are determined according to properties of the solid material. It is preferred to employ conditions of pressing time, pressing temperature and pressure as well as pressurization means, that cause no substantial plastic deformation of inorganic particles in the inorganic structure, and allow only the solid material to undergo plastic deformation and can fill voids of the inorganic particle structure.

It is possible to confirm plastic deformation of the inorganic particle layer by cross-sectional observation using an electron microscope (for example, SEM or STEM).

For the purpose of facilitating plastic deformation, auxiliary means may be used in addition to pressurization. Herein, the auxiliary means refers to a method of increasing plasticity of a solid material having plasticity. Examples of the method of increasing plasticity of the solid material having plasticity include a method of softening a solid material by heating, a method of softening a solid material by reacting a chemical substance, and a method of increasing affinity and slippage between a solid material and the void surface of an inorganic particle layer. Of these methods, the method of softening a solid material by heating is preferably used.

Examples of the method of softening a solid material by heating include a method of heating the entire inorganic particle structure, and a method of locally heating a solid material in an inorganic particle structure.

Examples of the method of heating the entire inorganic particle structure include a method of introducing an inorganic particle structure in a heating atmosphere using an oven or a heater, a method of bringing an inorganic particle structure into contact with a heat medium such as a heated metal plate, a method of pressurizing after bringing an inorganic particle structure into contact with a heat roll (heated roll), and a method of bringing an inorganic particle structure into contact with a heat roll.

Examples of the method of locally heating a solid material include a method of heating by irradiation with electromagnetic waves, for example, irradiation with infrared ray, laser, microwave, light in a high dose within a very short time (flash-annealing method), radiation such as electron beam or the like, and a method of cooling other portions while bringing only any selected portion of an inorganic particle structure into contact with a heat medium. When the solid material is metal, induction heating using magnetic line, and irradiation with various electromagnetic waves described above can be used.

The temperature, pressure and time of the press are not particularly limited since they vary depending on properties of the solid material, and conditions suited for filling of the solid material into the void portion of the inorganic particle layer are used.

When the solid material is a film-like polypropylene, the lower limit of the press temperature is preferably 120° C. or higher, and more preferably 125° C. or higher. Since the entire surface of the inorganic particle layer is coated with polypropylene, adhesion between a photocatalyst layer and an inorganic particle layer deteriorates, and therefore the press temperature is preferably 160° C. or lower, and more preferably 155° C. or lower. When the solid material is a film-like polyethylene terephthalate, the lower limit of the press temperature is preferably 110° C. or higher, and more preferably 130° C. or higher. Since the entire surface of the inorganic particle layer is coated with polyethylene terephthalate, adhesion between a photocatalyst layer and an inorganic particle layer deteriorates, and therefore the press temperature is preferably 210° C. or lower, and more preferably 190° C. or lower. Furthermore, when the solid material is a film-like polyvinyl chloride, the lower limit of the press temperature is preferably 60° C. or higher, and more preferably 80° C. or higher. Since the entire surface of the inorganic particle layer is coated with polyvinyl chloride, adhesion between a photocatalyst layer and an inorganic particle layer deteriorates, and therefore the press temperature is preferably 200° C. or lower, and more preferably 180° C. or lower.

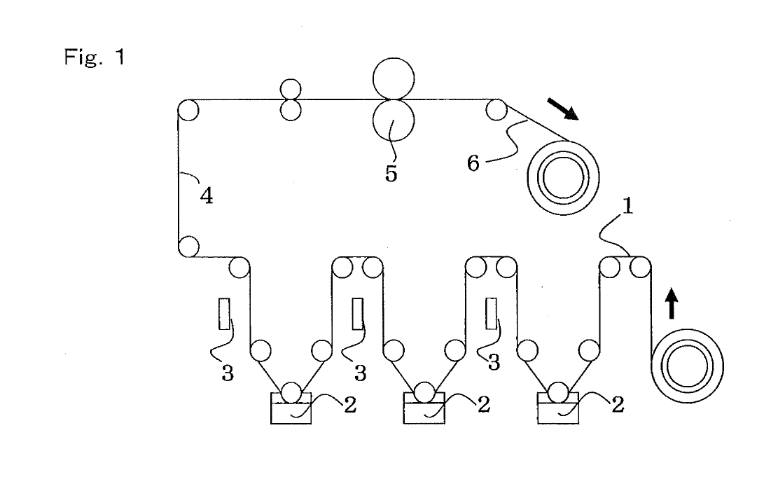

FIG. 1 is a schematic explanatory diagram showing an example of production process of an inorganic particle composite according to the present invention. As shown in the same drawing, according to this production process, an inorganic particle structure 4 can be obtained by coating an inorganic particle-dispersed coating solution 2 plural times on a synthetic resin film 1 such as a polypropylene, polyethylene terephthalate or polyvinyl chloride film, and drying the solution using a dryer 3, thereby laminating (disposing) an inorganic particle layer on the surface of the film 1. The obtained inorganic particle structure 4 is allowed to undergo plastic deformation by pressing using a hot roll press 5, thereby combining the base material (synthetic resin film 1) with the inorganic particle structure 4, and thus an inorganic particle composite 6 can be obtained.

### [Photocatalyst Composite]

The photocatalyst composite of the present invention can be obtained by forming a photocatalyst layer on the surface of the inorganic particle layer of the obtained inorganic particle composite. The shape of the photocatalyst composite is not particularly limited, and the shape suited for required functions and applications is used. Examples of the shape include plate such as film or sheet, bar, fiber, sphere, three-dimensional structure and the like.

The photocatalyst layer can be formed, for example, by a conventionally known film formation method comprising dispersing a photocatalyst in a suitable dispersion to obtain a photocatalyst dispersion; optionally adding a binder for a photocatalyst layer to fix firmly am inorganic particle layer on the surface of an inorganic particle composite, a surfactant for improving wettability between the photocatalyst dispersion and the surface of an inorganic particle composite and the like to the photocatalyst dispersion; coating the photocatalyst dispersion on the surface of the inorganic particle composite; and vaporizing the dispersion medium. Needless to say, it is also possible to obtain a photocatalyst composite by coating a photocatalyst dispersion on the surface of the inorganic particle structure 4 in advance; allowing a solid material of an inorganic particle structure to undergo plastic deformation through heating, pressurization or the like; and simultaneously forming a photocatalyst layer.

When the photocatalyst dispersion in the present invention contains a noble metal or a precursor thereof, the noble metal or precursor thereof is supported on the surface of a photocatalyst. The supported precursor is converted into the noble metal by, for example, irradiation with light. There is no particular limitation on the thickness of the photocatalyst layer and, usually, the thickness may be appropriately set within a range from several hundreds nm to several mm according to applications. The photocatalyst layer may be formed at any position as long as it may be formed on the surface of the inorganic particle composite. For example, the photocatalyst layer is preferably formed on the surface to be irradiated with light (visible ray), the surface being spatially connected continuously or intermittently with the position where a bad smell substance is generated or the position where pathogenic bacteria are present.

### [Photocatalytic Functional Product]

In the photocatalytic functional product in the present invention, the photocatalyst composite is utilized for the surface of base materials that are intended to be in contact with unspecified number of the general public, for example, construction materials such as ceiling material, tile, glass, wall paper, wall material, floor, etc.; automotive interior materials (automotive instrument panel, automotive sheet, automotive ceiling material, etc.); household electrical appliances such as refrigerator, air conditioner, etc.; textile products such as clothes, curtain, etc.; touch panel, train hand strap, elevator button, etc. Since the photocatalyst composite exhibits a high photocatalytic activity under light irradiation in an indoor atmosphere exposed only to light from a visible light source such as a fluorescent lamp, a sodium lamp or light-emitting diode, not to mention outdoors, the photocatalytic functional product in the present invention reduces the concentrations of volatile organic substances such as formaldehyde, acetaldehyde, etc., bad smell substances such as aldehydes, mercaptans, ammonia, etc., and nitrogen oxides under light irradiation due to interior illumination, thus making it possible to extinct, decompose and remove pathogenic bacteria such as Staphylococcus aureus, Escherichia coli, anthrax bacilli, Bacillus tuberculosis, cholera bacillus, diphtheria bacillus, tetanus bacilli, Bacillus pestis, Bacillus dysentericus, botulism bacillus, Legionella pneumophilia, etc., and also can detoxify turkey herpes virus, Marck's disease virus, Infectious bursal disease virus, Newcastle disease virus, infectious bronchitis virus, infectious laryngotracheitis virus, avian encephalomyelitis virus, chicken anemia virus, fowlpox virus, avian reovirus, avian leukemia virus, reticuloendotheliosis virus, avian sadenovirus and hemorrhagic enterocolitis virus, herpes virusvirus, smallpox virus, cowpox virus, chicken pox virus, measles virus, adenovirus, coxsackie virus, calici virus, retrovirus, coronavirus, avian influenza virus, human influenza virus, swine flu virus, norovirus, and recombinants, etc., and also can detoxify allergens such as mite allergen and cedar pollenallergen, etc. The photocatalytic functional product of the present invention exhibit sufficient hydrophilicity and anti-fog properties under irradiation with visible ray, and also can easily wipe off stains only by spraying water and can prevent electrostatic charge.

### EXAMPLES

The present invention will be described in detail below by way of Examples, but the present invention is not limited to these Examples.

The measurement of physical properties and evaluation of photocatalytic activity in Examples and Comparative Examples were performed by the following methods.

### (Crystal Form)

Using an X-ray diffractometer (“RINT2000/PC”, manufactured by Rigaku Corporation), an X-ray diffraction spectrum was measured and a crystal form (crystal structure) was determined from the spectrum.

### (Bet Specific Surface Area)

Using a specific surface area meter (“Monosorb”, manufactured by YUASA-IONICS COMPANY, LIMITED.), BET specific surface area was measured by a nitrogen adsorption method.

### (Average Dispersion Particle Diameter)

Using a submicron particle size distribution analyzer (“N4Plus”, manufactured by Coulter Corporation), particle size distribution was measured and automatically analyzed with a monodispersion mode by a software attached to this apparatus. The result was made to be an average dispersed particle diameter (nm).

### (Electron Microscope Observation-SEM)

An inorganic particle structure or an inorganic particle composite was cut by a microtome and the surface was coated with osmium, and then observation was carried out using a scanning electron microscope (SEM, field emission scanning electron microscope (FE-SEM), model number: S-800, manufactured by Hitachi, Ltd.). In the case, the surface and the section of samples were observed in a state of being tilted by 30 degrees.

### (Electron Microscope Observation-STEM)

A photocatalyst composite was processed into a thin section by focused ion beam and scanning transmission electron microscope (STEM) observation was carried out using an electron microscope (JEM-2100F, manufactured by JEOL, Ltd.).

### (Adhesion)

Adhesion (adhesion property) of a photocatalyst layer in a photocatalyst composite was evaluated by the following procedure. An adhesive cellophane tape was adhered onto the photocatalyst layer and peeled quickly. Adhesion was evaluated whether or not the photocatalyst layer is peeled.

### (Evaluation of Photocatalytic Activity)

A photocatalyst composite to be measured was cut into pieces measuring 5 cm×10 cm and was irradiated with ultraviolet light from a black light for 16 hours so as to have the ultraviolet light strength of 2 mW/cm² (as measured by attaching a light receive part “UD-36” manufactured by TOPCON CORPORATION to a UV intensity meter “UVR-2” manufactured by the same company) and the obtained sample was used as a sample for the measurement of photocatalytic activity.

The obtained sample for the measurement of photocatalytic activity was put in a gas bag (having an inner capacity of 1 L) and the bag was sealed, following by making the inside of the gas bag to be a vacuum state. A mixed gas (469 mL) of oxygen and nitrogen in a volume ratio of 1:4 was enclosed in the gas bag, and also a nitrogen gas of 9 mL containing acetaldehyde by 1 volume % was enclosed in the gas bag so that the concentration of acetaldehyde became 20 ppm. After keeping it in a dark space at a room temperature for 1 hour, the gas bag was set so that an illuminance near the measuring sample from a commercial white fluorescent light as a light source was to be 6,000 lux (measured by an illuminometer “T-10” manufactured by Minolta Co., Ltd.) and then the decomposition reaction of acetaldehyde was performed. The intensity of ultraviolet light near the measuring sample was 40 μW/cm² (measured by using an ultraviolet intensity meter “UVR-2”, manufactured by Topcon Corporation in which a light receiving part “UD-36” manufactured by the same corporation to the meter was attached). The gas in the gas bag was sampled every 1.5 hours after irradiating a fluorescent light, the residual concentration of acetaldehyde was measured by a gas chromatograph (“GC-14A”, manufactured by Shimadzu Corporation) so as to calculate a first-order reaction rate constant from the acetaldehyde concentration with respect to the irradiation time of 4.5 hours. The calculated first-order reaction rate constant was to be an acetaldehyde decomposing ability. When the first-order reaction rate constant is greater, the acetaldehyde decomposing ability is greater.

### Example 1

### Photocatalyst Dispersion

To 4 kg of ion-exchange water as a dispersion medium, 1 kg of tungsten oxide particles (manufactured by NIPPON INORGANIC COLOUR & CHEMICAL CO., LTD.) were added, followed by mixing to obtain a mixture. The obtained mixture was subjected to a dispersion treatment under the following conditions using a wet media agitation mill [“Ultra Apex Mill UAM-1”, manufactured by Kotobuki Engineering & Manufacturing Co., Ltd.] to obtain a tungsten oxide particle dispersion.

Milling media: 1.85 kg of zirconia beads having a diameter of 0.05 mm

Stirring speed: peripheral speed of 12.6 m/seconds

Flow rate: 0.25 L/minute

Treating time: about 50 minutes

The average particle diameter of tungsten oxide particles in the obtained tungsten oxide particle dispersion was 118 nm. One portion of the dispersion was vacuum-dried to obtain the solid part. As a result, the BET specific surface area of the obtained solid part was 40 m²/g. The mixture before the dispersion treatment was vacuum-dried in the same manner to obtain the solid part. With respect to the solid part of the mixture before the dispersion treatment and the solid part of the mixture after the dispersion treatment, X-ray diffraction spectrum was respectively measured and compared. As a result, the peak shape was the same and a change in crystal form (crystal structure) due to the dispersion treatment was not observed. At this time, the obtained dispersion was stored at 20° C. for 24 hours. As a result, no solid-liquid separation was observed during storage.

To the tungsten oxide particle dispersion, aqueous solution of hexachloroplatinic acid (H₂PtCl₆) was added so that the amount of hexachloroplatinic acid was 0.12 part by mass in terms of a platinum atom based on 100 parts by mass of the use amount of the tungsten oxide particles to obtain hexachloroplatinic acid-containing tungsten oxide particle dispersion as a raw dispersion. The amount of the solid part (amount of tungsten oxide particles) contained in 100 parts by mass of the dispersion was 17.6 parts by mass (solid part concentration: 17.6% by mass). This dispersion had a pH of 2.0.

500 g of the above hexachloroplatinic acid-containing tungsten oxide particle dispersion was circulated at a rate of 1 L per minute and the pH of the hexachloroplatinic acid-containing tungsten oxide particle dispersion was controlled to 3.0 by adding ammonia water from a pH controller while being irradiating with light (ultraviolet light) using light irradiation apparatus composed of a glass tube measuring (37 mm in inner diameter, 360 m in height) equipped with a pH electrode and the pH controller (set to pH 3) having a mechanism of controlling the pH to a set value by supplying 0.1% by mass ammonia water connected to the pH electrode and further provided with an underwater germicidal lamp [“GLD15MQ”, manufactured by SANKYO DENKI CO., LTD.]. The time of light irradiation of the dispersion was 1.5 hours. Subsequently, 15 g of an aqueous 50% by mass methanol solution was added while circulating, and the dispersion was irradiated with light (ultraviolet light) for 1.5 hours. During light irradiation, ammonia water was added by the pH controller and the pH of the dispersion was maintained at 3.0. The total amount of the ammonia water consumed before light irradiation and during light irradiation was 71.6 g.

The obtained platinum-supported tungsten oxide particle dispersion was stored at 20° C. for 24 hours, no solid-liquid separation was observed after storage. The solid part concentration in the dispersion was 15% by mass and the viscosity was 100.0 cP.

Water was added in the obtained platinum-supported tungsten oxide particle dispersion and the solid part concentration was diluted to 7.1% by mass, and 180 g of ethanol was added to 420 g of the solution to obtain a photocatalyst dispersion. The solid part concentration of the photocatalyst dispersion was 5% by mass.

### Photocatalyst Coating Solution 1

To 100 g (31 g in terms of ZrO₂) of zirconium hydroxide, 100 g of water was added, followed by well stirring to obtain a dispersion. As the first addition of oxalic acid, 31.7 g (molar ratio of oxalic acid/Zr=1.0) of oxalic acid dehydrate was added to the dispersion, followed by heating at 90° C. for 15 minutes. Next, as the second addition of oxalic acid, 15.8 g (molar ratio of oxalic acid/Zr=0.5) of oxalic acid dehydrate was added to the dispersion, followed by heating at 90° C. for 15 minutes to obtain a sol. To 100 g (about 12 g in terms of ZrO₂) of the obtained sol, 500 g of water was added, an operation of ultrafiltration using an ultrafiltration membrane (molecular weight cutoff: 6,000) was repeated four times until 500 g of the dispersion medium was removed to obtain 100 g of zirconium oxalate. A molar ratio of oxalic acid/Zr in the sol calculated from the oxalic acid concentration of the dispersion medium removed by ultrafiltration was 1.3. The sol was diluted with water so that the solid part concentration in terms of ZrO₂ became 9.9% by mass.

To a solution prepared by mixing 30.2 g of water with 60.0 g of ethanol, 69.4 g of a high-purity ethyl ortho-silicate (manufactured by TAMA CHEMICALS CO., LTD.) was added, followed by mixing under stirring. Furthermore, 40.4 g of zirconium oxalate (concentration in terms of ZrO₂: 9.9% by mass) obtained above was added, followed by stirring. The obtained mixture (20.8 g) was diluted by adding 29.2 g of an aqueous 30% by mass ethanol solution to obtain a binder for a photocatalyst layer.

To 570 g of the photocatalyst dispersion obtained above, 30 g of the obtained binder for a photocatalyst layer was added, and also an acetylene glycol-based surfactant (manufactured by Nissin Chemical Industry CO., Ltd. under the trade name of Olfin EXP. 4036) was added so that the concentration became 0.1% by mass based on the total amount of the photocatalyst dispersion and the binder for a photocatalyst layer to obtain a photocatalyst coating solution 1.

(Coating Solution for Formation of Inorganic Particle layer)

200 g of ST-XS (colloidal silica manufactured by Nissan Chemical Industries, Ltd.; average particle diameter: 4 to 6 nm; solid part concentration: 20% by mass), 400 g of ST-ZL (colloidal silica manufactured by Nissan Chemical Industries, Ltd.; average particle diameter: 78 nm; solid part concentration: 40% by mass), 100 g of pure water and 300 g of isopropyl alcohol were mixed under stirring to prepare a coating solution for formation of an inorganic particle layer.

### (Production of Inorganic Particle Structure 1)

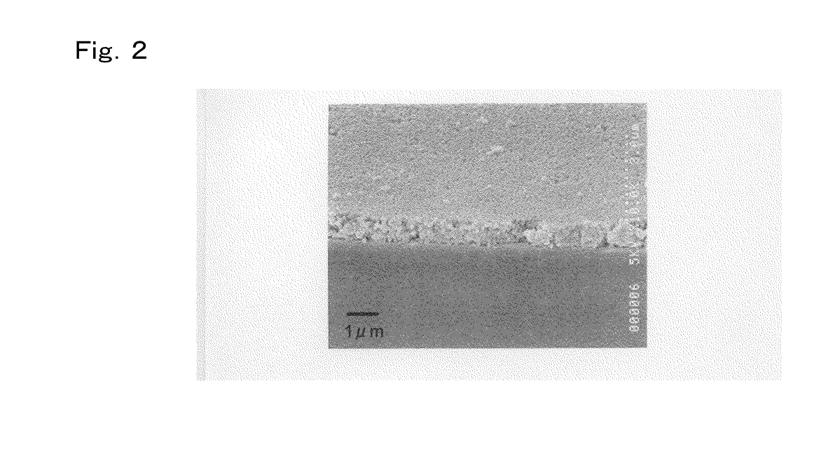

Using a film (melting point: 160° C. thickness: about 100 μm) made of a polypropylene homopolymer as a solid material, the surface of the film was coated with the coating solution for formation of an inorganic particle layer using a microgravure roll (manufactured by Yasui Seiki Co., 230 mesh) and dried at 50° C. Furthermore, the coating solution with the same components was coated on the surface of the film using a microgravure roll (manufactured by Yasui Seiki Co., 230 mesh) and dried at 50° C. to obtain an inorganic particle structure 1. A SEM micrograph of the inorganic particle structure 1 is shown in FIG. 2. The surface of the inorganic particle structure 1 only has an inorganic particle layer and the cross section observation revealed that the inorganic particle layer has a thickness of about 0.8 μm. The surface of the inorganic particle structure 1 has a pencil hardness of less than 6B.

### (Production of Inorganic Particle Composite 1)

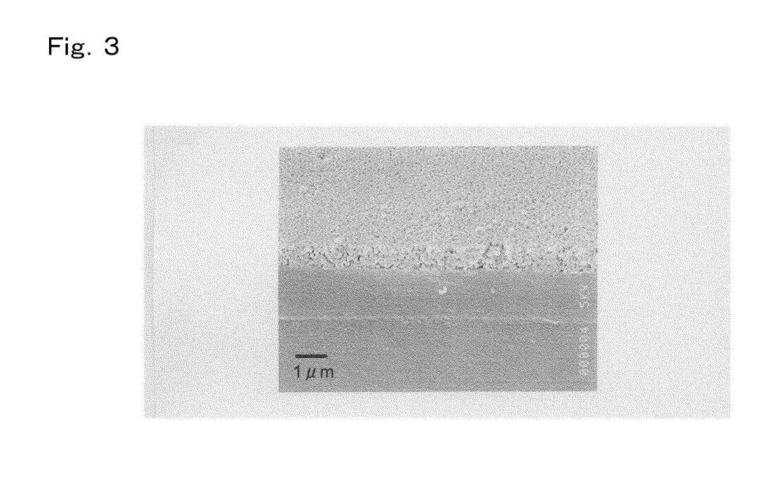

The above inorganic particle structure 1 was subjected to a press treatment under the condition of primary compression at 130° C. under 70 kgf/cm² for 5 minutes and secondary compression at 30° C. under 70 kgf/cm² for 5 minutes using a compression molding machine (manufactured by SHINTO Metal Industries Corporation) to obtain an inorganic particle composite 1. A SEM micrograph of the inorganic particle composite 1 is shown in FIG. 3. On the surface of the inorganic particle composite, only an inorganic particle layer was present. The pencil hardness of the surface of the inorganic particle composite 1 is shown in Table 1.

The SEM observation revealed that a polypropylene homopolymer as the solid material is filled in voids in the inorganic particles layer, and that inorganic particles do not undergo plastic deformation in the above press treatment, whereby, the solid material underwent plastic deformation.

### (Production of Photocatalyst Composite 1)

The above inorganic particle composite 1 (measuring 7 cm×15 cm) was coated with the photocatalyst coating solution 1 using a bar coater (No. 6) and dried at 70° C. for 15 minutes to obtain a photocatalyst composite 1. The adhesion of the photocatalyst layer of the photocatalyst composite 1 is shown in Table 1.

### Example 2

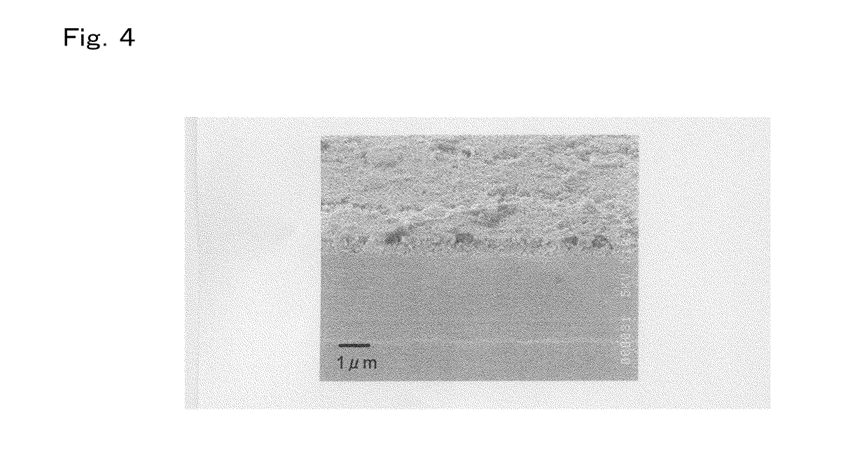

In the same manner as in Example 1, except that the temperature of the primary compression when producing the inorganic particle composite 1 in Example 1 was controlled to 150° C., an inorganic particle composite was obtained. The SEM micrograph of the inorganic particle composite is shown in FIG. 4. The surface of the inorganic particle composite was mainly composed of only the inorganic particle layer, but polypropylene was observed at one portion. The pencil hardness of the surface of the inorganic particle composite is shown in Table 1.

Next, in the same manner as in Example 1, a photocatalyst composite was obtained. The adhesion of the photocatalyst layer of the photocatalyst composite is shown in Table 1.

### Comparative Example 1

On a film (melting point: 160° C., thickness: about 100 μm) made of a polypropylene homopolymer as a solid material, the photocatalyst coating solution 1 was directly coated using a bar coater (No. 6) and dried at 70° C. for 15 minutes to obtain a photocatalyst composite. The adhesion of the photocatalyst layer of the photocatalyst composite is shown in Table 1.

### Comparative Example 2

On inorganic particle structure 1 obtained in Example 1, the photocatalyst coating solution 1 was bar coated using a bar coater (No. 6) and dried at 70° C. for 15 minutes to obtain a photocatalyst structure. The adhesion of the photocatalyst layer of the photocatalyst composite is shown in Table 1.

### Comparative Example 3

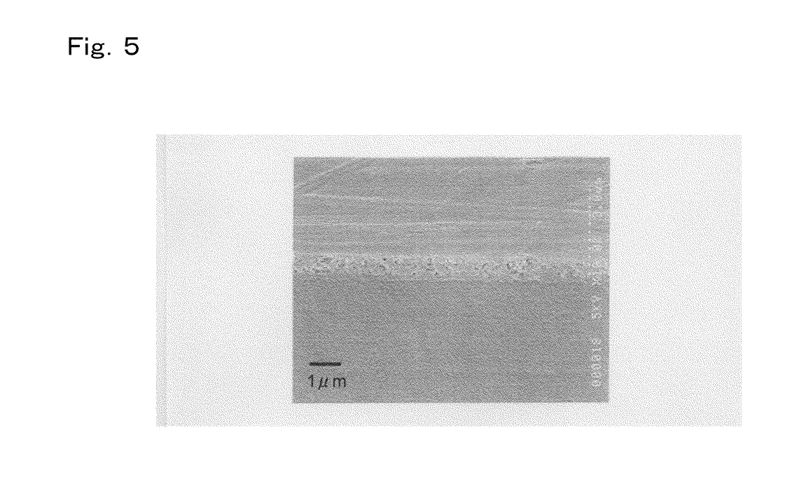

In the same manner as in Example 1, except that the temperature of the primary compression when producing the inorganic particle composite 1 in Example 1 was controlled to 165° C., an inorganic particle composite was obtained. The SEM micrograph of the inorganic particle composite is shown in FIG. 5. The entire surface of the inorganic particle composite was coated with polypropylene. The pencil hardness of the surface of the inorganic particle composite is shown in Table 1.

In the same manner as in Example 1, a photocatalyst composite was obtained. The adhesion of the photocatalyst layer of the photocatalyst composite is shown in Table 1.

Physical properties of the inorganic particle structure, the inorganic particle composite and the photocatalyst composite obtained in Examples 1, 2 and Comparative Examples 1 to 3 are shown in Table 1.

TABLE 1

| | | Press | | | |
|---|---|---|---|---|---|
| | Inorganic | Temperature | Pencil Hardness | Adhesion of | |
| | Particle | of Primary | of Inorganic | Photocatalyst | Over-all |
| | Layer | Compression | Particle Composite | Layer | Judgment |
| Example 1 | Exist | 130° C. | 2B | Good | ◯ (good) |
| Example 2 | Exist | 150° C. | B | Good | ◯ (good) |
| Comparative | Not Exist | Not Applied | No Inorganic | Entirely | X (bad) |
| Example 1 | | | Particle composite | Peeled off | |
| Comparative | Exist | Not Applied | Less than 6B | Good | X (bad) |
| Example 2 | | | | | |
| Comparative | Exist | 165° C. | B | Entirely | X (bad) |
| Example 3 | | | | Peeled off | |

With respect to Examples 1 and 2 in which physical properties were rated “◯” (good) in over-all judgment in Table 1, and Comparative Example 3 in which the pencil hardness of the inorganic particle composite was the same level as that of Example 2, photocatalytic performances of the photocatalyst composites were evaluated for comparison. The results are shown in Table 2.

TABLE 2

| | First-order |
|---|---|
| | Reaction Rate |
| | Constant (h⁻¹) |
| Example 1 | 0.944 |
| Example 2 | 0.563 |
| Comparative | 0.451 |
| Example 3 | |

It was shown that the photocatalyst composites of Examples 1 and 2 exhibit satisfactory physical properties and high photocatalytic activity.

### Example 3

### Photocatalyst Coating Solution 2

To a solution prepared by mixing 26 g of a high-purity ethyl ortho-silicate (manufactured by TAMA CHEMICALS CO., LTD.) with 120 g of ethanol, 193 g of water was added, followed by mixing under stirring. Furthermore, 61 g of colloidal silica (manufactured by Nissan Chemical Industries, Ltd., STOS: 20.4% by mass) was added, followed by stirring to obtain a binder for a photocatalyst layer.

To 80 g of the obtained binder for a photocatalyst layer, 320 g of the photocatalyst dispersion obtained in Example 1 was added to obtain a photocatalyst coating solution 2.

### (Production of Inorganic Particle Structure 2)

Using a film (melting point: 260° C., thickness: 100 μm) made of polyethylene terephthalate as a solid material, a coating solution for formation of an inorganic particle layer, that is the same as that in Example 1, was coated on the surface of the film using a microgravure roll (manufactured by Yasui Seiki Co., 230 mesh) followed by drying at 50° C. Then, using a coating solution with the same components, the coating solution was coated on the surface of the film using a microgravure roll (manufactured by Yasui Seiki Co., 230 mesh) and dried at 50° C. to obtain an inorganic particle structure 2. The pencil hardness of the surface of the inorganic particle structure 2 was 4B.

### (Production of Inorganic Particle Composite 2)

Using a hot roll press (a sleeve touch system manufacturing equipment, manufactured by CHIBA MACHINE INDUSTRY CORPORATION), the above inorganic particle structure 2 was subjected to a press treatment under the conditions of a heating temperature of 180° C. and a throughput speed of 5 m/minute to obtain an inorganic particle composite 2. On the surface (upper surface) of the inorganic particle composite 2, only an inorganic particle layer was present. The pencil hardness of the surface of the inorganic particle composite 2 is shown in Table 3. On the surface (upper surface) of the inorganic particle composite 2, only an inorganic particle layer was present.

### (Production of Photocatalyst Composite 2)

On the above inorganic particle composite 2 (measuring 7 cm×15 cm), the photocatalyst coating solution 2 was coated using a bar coater (NO. 6) and dried at 70° C. for 15 minutes to obtain a photocatalyst composite 2. The adhesion of the photocatalyst layer of the photocatalyst composite 2 is shown in Table 3. The cross-sectional observation revealed that the inorganic particle layer has a thickness of about 0.55 μm and the photocatalyst layer has a thickness of about 0.31 μm.

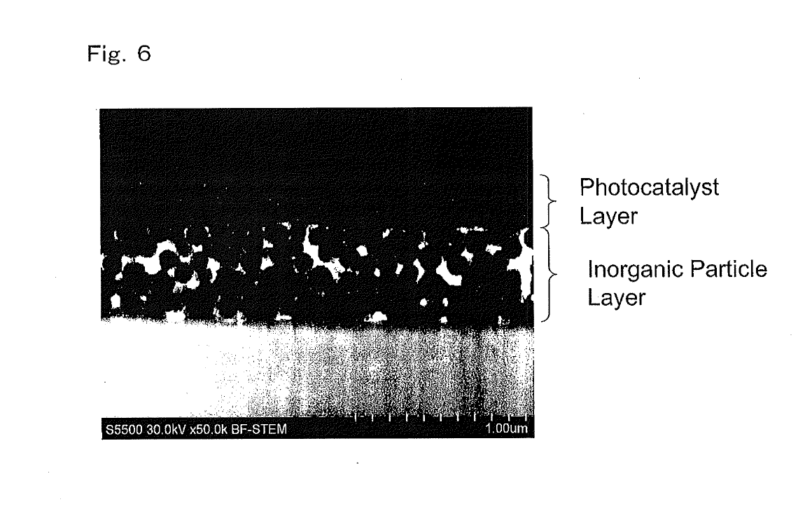

FIG. 6 shows the results of a cross-sectional STEM observation of the obtained photocatalyst composite 2. Polyethylene terephthalate is filled in voids of the inorganic particles layer. It is apparent that inorganic particles (silica) maintain a generally spherical shape and do not undergo plastic deformation.

### Comparative Example 4

On a film (melting point: 260° C., thickness: about 100 μm) made of a polyethylene terephthalate as a solid material, the photocatalyst coating solution 2 was directly coated using a bar coater (No. 6) and dried at 70° C. for 15 minutes to obtain a photocatalyst composite. The adhesion of the photocatalyst layer of the photocatalyst composite is shown in Table 3.

### Comparative Example 5

On the inorganic particle structure 2 obtained in Example 3, the photocatalyst coating solution 2 was coated using a bar coater (No. 6) and dried at 70° C. for 15 minutes to obtain a photocatalyst structure. The adhesion of photocatalyst layer of the photocatalyst structure is shown in Table 3.

TABLE 3

| | Inorganic | | Pencil Hardness | Adhesion of | |
|---|---|---|---|---|---|
| | Particle | Press | of Inorganic | Photocatalyst | Over-all |
| | Layer | Temperature | Particle Layer | Layer | Judgment |
| Example 3 | Exist | 180° C. | 2B | Good | ◯ (good) |
| Comparative | Not Exist | Not Applied | No Inorganic | Entirely | X (bad) |
| Example 4 | | | Particle Composite | Peeled off | |
| Comparative | Exist | Not Applied | 4B | Entirely | X (bad) |
| Example 5 | | | | Peeled off | |

With respect to Example 3 in which physical properties were rated “◯” (good) in over-all judgment in Table 3, photocatalytic performances of the photocatalyst composite were evaluated. As a result, the first-order reaction rate constant was 0.668 h⁻¹.

### Reference Example 1

When the photocatalyst composites obtained in Examples 1, 2 and 3 are used for the surface of a ceiling material constituting ceiling, it is possible to reduce the concentrations of volatile organic substances (for example, formaldehyde, acetaldehyde, acetone, toluene, etc.) and bad smell substances in the interior space under light irradiation due to interior illumination, and to kill pathogenic bacteria such as Staphylococcus aureus, Escherichia coli, etc. as well as virus such as influenza virus, etc., and to detoxify allergens such as mite allergen, cedar pollen allergen, etc. Furthermore, the surface of the base material is hydrophilized, thus making it possible to easily wipe off stains and to prevent electrostatic charge.

### Reference Example 2

When the photocatalyst composites obtained in Examples 1, 2 and 3 are used for the surface of tiles applied on the wall surface in the room, it is possible to reduce the concentrations of volatile organic substances (for example, formaldehyde, acetaldehyde, acetone, toluene, etc.) and bad smell substances in the interior space under light irradiation due to interior illumination, and to kill pathogenic bacteria such as Staphylococcus aureus, Escherichia coli, etc. as well as virus such as influenza virus, etc., and to detoxify allergens such as mite allergen, cedar pollen allergen, etc. Furthermore, the surface of the base material is hydrophilized, thus making it possible to easily wipe off stains and to prevent electrostatic charge.

### Reference Example 3

When the photocatalyst composites obtained in Examples 1, 2 and 3 are used for the surface of the indoor side of a window pane, it is possible to reduce the concentrations of volatile organic substances (for example, formaldehyde, acetaldehyde, acetone, toluene, etc.) and bad smell substances in the interior space under light irradiation due to interior illumination, and to kill pathogenic bacteria such as Staphylococcus aureus, Escherichia coli, etc. as well as virus such as influenza virus, etc., and to detoxify allergens such as mite allergen, cedar pollen allergen, etc. Furthermore, the surface of the base material is hydrophilized, thus making it possible to easily wipe off stains and to prevent electrostatic charge.

### Reference Example 4

When the photocatalyst composites obtained in Examples 1, 2 and 3 are used for the surface of a wall paper, it is possible to reduce the concentrations of volatile organic substances (for example, formaldehyde, acetaldehyde, acetone, toluene, etc.) and bad smell substances in the interior space under light irradiation due to interior illumination, and to kill pathogenic bacteria such as Staphylococcus aureus, Escherichia coli, etc. as well as virus such as influenza virus, etc., and to detoxify allergens such as mite allergen, cedar pollen allergen, etc. Furthermore, the surface of the base material is hydrophilized, thus making it possible to easily wipe off stains and to prevent electrostatic charge.

### Reference Example 5

When the photocatalyst composites obtained in Examples 1, 2 and 3 are used for the floor surface in the room, it is possible to reduce the concentrations of volatile organic substances (for example, formaldehyde, acetaldehyde, acetone, toluene, etc.) and bad smell substances in the interior space under light irradiation due to interior illumination, and to kill pathogenic bacteria such as Staphylococcus aureus, Escherichia coli, etc. as well as virus such as influenza virus, etc., and to detoxify allergens such as mite allergen, cedar pollen allergen, etc. Furthermore, the surface of the base material is hydrophilized, thus making it possible to easily wipe off stains and to prevent electrostatic charge.

### Reference Example 6

When the photocatalyst composites obtained in Examples 1, 2 and 3 are used for the surface of automotive interior materials such as automotive instrument panel, automotive sheet, automotive ceiling material, etc. it is possible to reduce the concentrations of volatile organic substances (for example, formaldehyde, acetaldehyde, acetone, toluene, etc.) and bad smell substances in the in-car space under light irradiation due to interior illumination, and to kill pathogenic bacteria such as Staphylococcus aureus, Escherichia coli, etc. as well as virus such as influenza virus, etc., and to detoxify allergens such as mite allergen, cedar pollen allergen, etc. Furthermore, the surface of the base material is hydrophilized, thus making it possible to easily wipe off stains and to prevent electrostatic charge.

### Reference Example 7

When the photocatalyst composites obtained in Examples 1, 2 and 3 are used for the surface of an air conditioner, it is possible to reduce the concentrations of volatile organic substances (for example, formaldehyde, acetaldehyde, acetone, toluene, etc.) and bad smell substances in the interior space under light irradiation due to interior illumination, and to kill pathogenic bacteria such as Staphylococcus aureus, Escherichia coli, etc. as well as virus such as influenza virus, etc., and to detoxify allergens such as mite allergen, cedar pollen allergen, etc. Furthermore, the surface of the base material is hydrophilized, thus making it possible to easily wipe off stains and to prevent electrostatic charge.

### Reference Example 8

When the photocatalyst composites obtained in Examples 1, 2 and 3 are used on the surface in a refrigerator, it is possible to reduce the concentrations of volatile organic substances (for example, formaldehyde, acetaldehyde, acetone, toluene, etc.) and bad smell substances in the interior space under light irradiation due to interior illumination, and to kill pathogenic bacteria such as Staphylococcus aureus, Escherichia coli, etc. as well as virus such as influenza virus, etc., and to detoxify allergens such as mite allergen, cedar pollen allergen, etc. Furthermore, the surface of the base material is hydrophilized, thus making it possible to easily wipe off stains and to prevent electrostatic charge.

### Reference Example 9

When the photocatalyst composites obtained in Examples 1, 2 and 3 are used for the surface of base materials that are intended to be in contact with unspecified number of the general public, for example, touch panel, rain hand strap, elevator button, etc., it is possible to reduce the concentrations of volatile organic substances (for example, formaldehyde, acetaldehyde, acetone, toluene, etc.) and bad smell substances in the interior space under light irradiation due to interior illumination, and to kill pathogenic bacteria such as Staphylococcus aureus, Escherichia coli, etc. as well as virus such as influenza virus, etc., and to detoxify allergens such as mite allergen, cedar pollen allergen, etc. Furthermore, the surface of the base material is hydrophilized, thus making it possible to easily wipe off stains and to prevent electrostatic charge.

This application claims priority on Japanese Patent Application No 2009-214943 and Japanese Patent Application No. 2010-075937. The disclosure of Japanese Patent Application No. 2009-214943 and Japanese Patent Application No. 2010-075937 is incorporated by reference herein.

What is claimed is:

1. A photocatalyst composite comprising,
a base material, at least the surface thereof being formed of a plastic-deformable solid material;
an inorganic particle layer containing inorganic particles and disposed on the surface of the base material; and
a photocatalyst layer containing a photocatalyst and disposed on the surface of the inorganic particle layer;
wherein, the solid material is filled in at least one portion of voids in the inorganic particle layer and the surface of the inorganic particle layer is coated with the solid material except for at least one portion.

2. The photocatalyst composite according to claim 1, wherein the inorganic particles do not undergo plastic deformation under the condition where the solid material undergoes plastic deformation.

3. The photocatalyst composite according to claim 1, wherein the inorganic particles constituting the inorganic particle layer are made of silica.

4. The photocatalyst composite according to claim 1, wherein the base material comprises a film of a solid material.

5. The photocatalyst composite according to claim 1, wherein the solid material is a thermoplastic resin.

6. The photocatalyst composite according to claim 1, wherein a noble metal or a noble metal precursor is supported on the photocatalyst of the photocatalyst layer.

7. The photocatalyst composite according to claim 6, wherein the noble metal is at least one kind of a noble metal selected from Cu, Pt, Au, Pd, Ag, Ru, Ir and Rh.

8. The photocatalyst composite according to claim 6, wherein the photocatalyst is a tungsten oxide particle.

9. A photocatalytic functional product provided with the photocatalyst composite according to claim 1.
